(19) United States
(12) Patent Application Publication
(10) Pub. No.: US 2014/0372543 A1
(43) Pub. Date: Dec. 18, 2014

(54) SYSTEM AND METHOD FOR MANAGING CONTACT INFORMATION REQUESTS IN A NETWORK

(71) Applicant: Bhavin Turakhia, Mumbai (IN)

(72) Inventor: Bhavin Turakhia, Mumbai (IN)

(21) Appl. No.: 14/304,850

(22) Filed: Jun. 13, 2014

(30) Foreign Application Priority Data
Jun. 14, 2013 (IN) 2023/MUM/2013

(51) Int. Cl. H04L 12/58

(52) U.S. Cl. CPC H04L 51/04
USPC 709/206

(57) ABSTRACT

In example embodiments, a system and method for managing contact information requests in a network are provided. When a first user does not have a particular value for a contact, the first user may trigger a process to obtain the value. Accordingly, a request is received at a contact management system from a user device of the first user that requests the value. A second user that is socially connected to the first user and having the value for the contact in an address book of the second user is determined. An electronic message is sent to a user device of the second user requesting the second user to provide the value to the first user. The value is provided to the first user based on an approval by the second user in response to the electronic message.

### CROSS-REFERENCE TO RELATED APPLICATIONS

The present application claims the benefit of priority under 35 U.S.C. §119 to Indian Application No. 2023/MUM/2013, filed on Jun. 14, 2013, which is incorporated herein by reference in its entirety.

### FIELD

The present disclosure relates generally to management of address books, and in a specific example embodiment, to managing contact information requests in a network.

### BACKGROUND

Typically, an individual may have a plurality of contact mechanisms that enable the individual to be reachable via multiple networks. For example, the individual may have a Facebook account, a Gmail account, and a mobile number. Social contacts of the individual (e.g., friends, colleagues) may have address books that contain one or more of the contact mechanisms (e.g., contact entries or information such as a mobile number) for the individual. However, in some cases, the social contact may require a particular contact mechanism or other information that does not exist in their address book.

### BRIEF DESCRIPTION OF DRAWINGS

Various ones of the appended drawings merely illustrate example embodiments of the present invention and cannot be considered as limiting its scope,

FIG. 1 is a diagram illustrating an example environment in which embodiments of a system for managing contacts in a network may be implemented.

FIG. 2 is a block diagram illustrating an example embodiment of a contact management system.

FIG. 3 is a flow diagram of an example a method for managing contact information requests in a network.

FIG. 4 is a flow diagram of an example method for determining asocial contact from whom to request a value.

FIG. 5 is a flow diagram of an example method for obtaining the value from the social contact.

FIGS. 6A and 6B are communication flow diagrams of an example method for managing contact information requests in the network.

FIG. 7 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Example embodiments described herein provide systems and methods for managing contact information requests in a network. When a first user does not have a particular value (e.g., phone number, address, birthday, e-mail address) for a contact, the first user may trigger a process to obtain the value. Accordingly, a request is received at a contact management system from a user device of the first user that requests the value. A second user that is socially connected to the first user and having the value for the contact in an address book of the second user is determined. An electronic message is sent to a user device of the second user requesting the second user to provide the value to the first user. The value is provided to the first user based on an approval by the second user in response to the electronic message. It is noted that the value may be any type of information that a user may store to their address book.

In example embodiments, the first user may perform a search to find contacts for which to request the value. As such, the first user may submit a contact search communication that includes a search criterion (e.g., first name, last name, e-mail address). One or more contacts that match the search criterion are determined. The one or more contacts that match the search criterion may be determined from the address books of other users e.g., the second user) based on the other users granting access to the first user to search their address books. Alternatively or in addition, the one or more contacts that match the search criterion may be determined from an address book of the first user. The first user may then select the contact for which to request the value.

By using embodiments of the present invention, contacts in address books may be easily updated without the need fir the user to randomly communicate with (e.g., via electronic means such as e-mail or phone call) a plurality of social contacts in order to find a social contact having the value. Accordingly, one or more of the methodologies discussed herein may obviate a need for manual user input in order to update a contact in the address book and for needless communications in order to discover a value for a contact. This may have the technical effect of reducing computing resources used by one or more devices within the system. Examples of such computing resources include, without limitation, processor cycles, network traffic, memory usage, storage space, and power consumption.

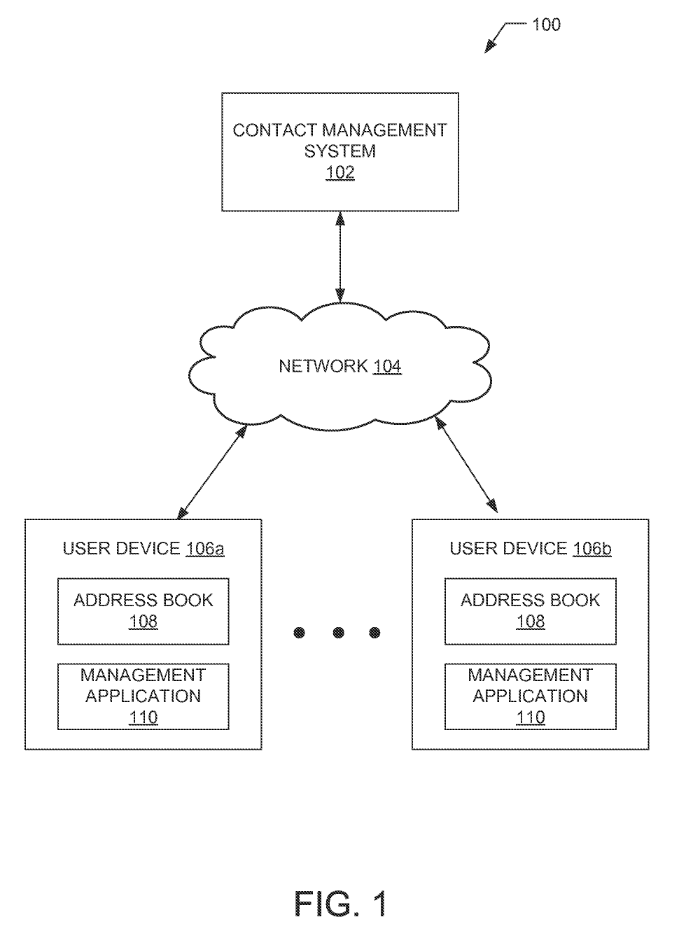

With reference to FIG. 1, a diagram illustrating an example environment 100 in which embodiments of a system for managing contact information requests is shown. The environment 100 comprises a contact management system 102 coupled via a network 104 (e.g., the Internet, wireless network, cellular network, or a Wide Area Network (WAN)) to a plurality of user devices 106 including a user device 106a, a user device 106b, and the like. Each user device 106 is associated with a user that maintains an address book 108 in their respective user device 106. The user device 106 may comprise a mobile phone, laptop, tablet, or any other communication device that a user may utilize to store, access, or manage the address book 108. The address book 108 comprises a data store of contact information for the user. The address book 108 is a contact list having a plurality of contacts (e.g., entries in the address book 108) whereby each contact contains one or more values (e.g., address, e-mail, phone number) that enable communication with an individual corresponding to the entry. It is noted that the terms “address book” and “contact list” may be used interchangeably.

The users of the user devices 106a and 106b may be socially connected such that the user of the user device 106a is a social contact of the user of the user device 106b and vice-versa. Two users may be socially connected, for example, when the two users indicate (e.g., to the contact management system 102 or to a social network system such as Facebook) that they know each other. For example, the two users may be friends, family, colleagues, or schoolmates. In other cases, two users may be socially connected via a third person. For example a first user may know a second user, and the second user may know a third user. The first user and the third user may be considered to be socially connected via the second user.

In example embodiments, a management application 110 is provisioned from the contact management system 102 to each user device 106. For example, when the user of the user device 106 initially signs up for service from the contact management system 102, the management application 110 may be provided to the user device 106. The management application 110 may be provided, for example but not limited to, by the user device 106 downloading the management application 110, the management application 110 being electronically sent to the user device 106, or the management application 110 being physically sent to the user (e.g., on a CD ROM).

Once the management application 110 is activated on the user device 106, the management application 110 may exchange information with the contact management system 102. In example embodiments, the management application 110 allows the user to search for contacts and send a request for a value for a particular contact. For example, the user may have an email address for a contact in their address book, but be missing a mobile number or a birthday for the contact. In another example, the user may search for a contact having a particular name or e-mail address and contacts that match either in their own address book or in address books of social contacts may be returned to the user from which the user can select a contact for which to request the value. The management application 110 may perform other functions such as enabling chat communications via the contact management system 102 or monitoring communications exchanges between the various users.

It is noted that the environment 100 shown in FIG. 1 is exemplary. Alternative embodiments may comprise any number of contact management systems 102 and user devices 106 in communication in the environment 100. Furthermore, while the address book 108 is shown as being located within the user device 106, in some embodiments, the user device 106 may access a remotely stored address book 108 (e.g., stored at the contact management system 102).

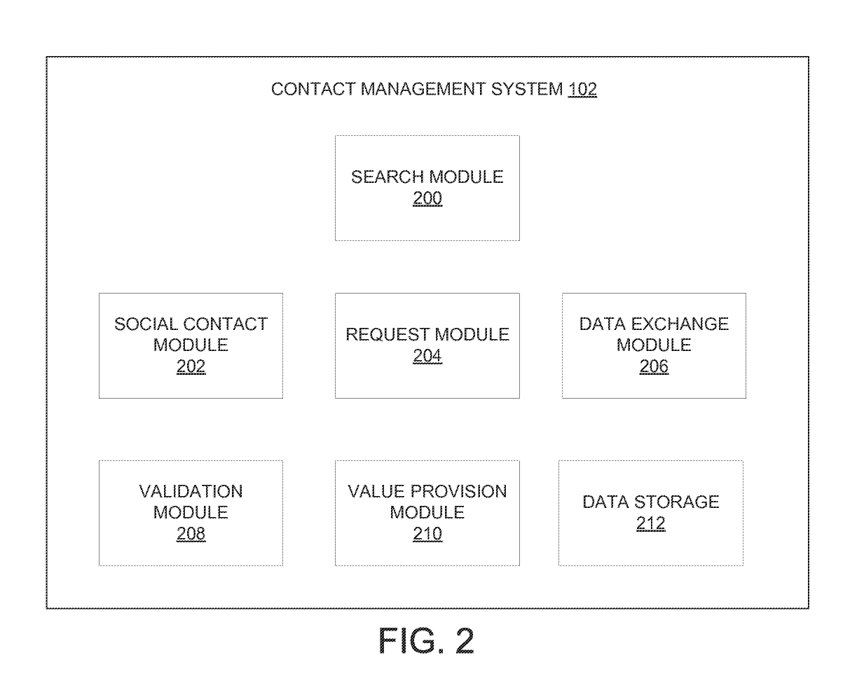

Referring now to FIG. 2, a block diagram illustrating an example embodiment of the contact management system 102 is shown. The contact management system 102 provides the management application 110 to the user devices 106 and manages the exchange of communications and values in the network. To enable these operations, the contact management system 102 comprises a search module 200, a social contact module 202, a request module 204, a data exchange module 206, a validation module 208, a value provision module 210, and a data storage 212 coupled in communication with each other. Alternative embodiments may comprise more, less, or other modules for managing contacts in the network. Some functions of the modules may be combined or divided into two or more further modules.

The search module 200 performs a search for a contact that matches a search criterion that is provided by the user. In example embodiments, the user may search for a contact having a particular name or e-mail address. The search module 200 takes the search criterion and determines matches in the address book of the user, in address books of social contacts, or both. The results are returned to the user, and the user may select one of the contacts in the results for which to request the value.

The social contact module 202 determines one or more social contacts of a user (e.g., friends, family, colleagues) that may have the value for the contact that is being requested or has provided permission to the user to search for contacts from their respective address books. Two users may be social contacts and are socially connected, for example, when the two users know each other or otherwise have a pre-existing relationship (e.g., direct relationship or relationship via one or more third parties). The relationship may be explicitly indicated by the user (e.g., marking the other users as friends) or be inherent (e.g., the user has contact information for the other users in their address book).

In order to determine social contacts that have the value being requested, in embodiments where the contact exists in the user's address book, the social contact module 202 may extract a known value for the contact from the address book of the (first) user. Using the known value, a second user (i.e., social contact) is identified based on the address book of the second user containing the known value for the contact. In some cases, the user that is requesting the value is socially connected to the second user by virtue of both users knowing the individual. In various examples, the known value for the contact may be an email address, a mobile number, a phone number, and a chat account. Thus, by using the known value, social contacts that have contact information for the individual are identified. If a corresponding field for the value is filled in the address book of the social contact for that individual, then that social contact is identified as having the value in their address book.

In some embodiments, the known value is extracted from the address book that is located at the user device of the requesting user and/or the social contacts. In other embodiments, the address book or a copy of the address book may be maintained at the contact management system 102 (e.g., in the data storage 212). In yet other embodiments, an external database may be accessed to find the socially connected contacts. It is noted that the social contacts do not need to be users of the contact management system 102.

Once the social contacts having the requested value are determined by the social contact module 202, the request module 204 may provide a notification to the user. The notification may indicate that one or more social contacts of the requesting user have the value. In one embodiment, the identities of the social contacts may not be provided to the requesting user, only an indication that there are social contacts that have the requested value. The notification also provides a mechanism (e.g., button, selection) for the user to trigger a process to obtain the value from one of the social contacts. For example when the user accesses the contact information for the individual in their address book, the user may be presented a user interface that shows an e-mail address for the individual but illustrates an empty mobile number field. The user interface may indicate that, for example, ten of user's social contacts (e.g., friends) have that value and provide a button that when selected will request the value from one or more of these social contacts.

The social contact module 202 may also determine an order of the social contacts from whom to request the value based on heuristics. In example embodiments, heuristics may be stored in the data storage 212 and accessed by the social contact module 202. In example embodiments, the “closest” social contacts or social contacts that are more likely to respond are chosen to receive an electronic message requesting the value first. For example, social contacts that the requesting user chats with or e-mails more often may be considered to be closer than social contacts that the requesting user seldom communicates with. In another example, social contacts that have responded in the past to electronic messages requesting values from the user are deemed to be more likely to respond to new electronic message requests. Other heuristics that may indicate a social contact's likelihood to respond to the electronic message may also be considered such as availability of the social contact in real time, a number of interactions between the user and the social contact, a number of past requests received by the social contact, and a number of past requests approved by the social contact. Additionally, the same social contacts should not be bombarded with an excess amount of electronic messages requesting values (e.g., no more than two requests sent to a particular social contact within a particular time period). Further still, social contacts may be selected who have the value that most other users have for the contact in order to increase a probability of the value's accuracy. All of these factors may be weighted and considered in determining the one or more social contacts that will receive the electronic message.

The social contact module 202 selects one or several (e.g., one to three) of the social contacts based on closeness or likelihood to respond) to send the electronic message. If none of the initial set of social contacts responds to the electronic message or denies the request, the social contact module 202 may select a next set of social contacts to receive the electronic message with the request. This process may be repeated until one of the social contacts approves the request to provide the value, a threshold time period expires (e.g., request for five days), the contact management system 102 runs out of social contacts to send the electronic message request, or a threshold number of sets of social contacts have been contacted (e.g., process repeated three times).

The request module 204 manages request communications from the various user devices 106. In example embodiments, the request module 204 receives the request for contact information corresponding to an individual in an address book of a user (e.g., from the user device 106 of the user). In some embodiments, the request module 204 may be a communications module configured to exchange communications with the various user devices 106. It is noted that in some cases, the individual may not want a particular value to be automatically shared between users. In these cases, the individual may select a setting that blocks the contact management system 102 from performing the processes described herein.

The data exchange module 206 manages a data exchange with the social contacts that have the requested value in order to obtain the requested value on behalf of the requesting user. Accordingly, the data exchange module 206 may send the electronic message to the social contact, requesting the social contact provide the value. In some embodiments, the electronic message may be sent by any means based on contact information (e.g., values) stored in a primary profile of the social contact. For example, the electronic message may be sent via e-mail if an e-mail address exists in the primary profile for the social contact or sent via text messaging if a mobile phone number exists in the primary profile for the social contact or via a chat message. The primary profile for the social contact may be stored in the data storage 212. The primary profile may comprise a set of one or more values (e.g., contact mechanisms) for each user that is registered with the contact management system 102.

An electronic response from the individual may also be received and processed by the data exchange module 206. If the electronic response is an approval of the request for the value, the value may be obtained from the address book of the accepting social contact. For example, a component of the management application 110 at the user device of the approving social contact may obtain the value from a locally stored address book and provide it to the data exchange module 206. In other embodiments, a component of the contact management system 102 may obtain the value from the (locally or remotely stored) address book of the accepting social contact. If the electronic response is a denial or no response is received after a threshold amount of time, the data exchange module 206 may send electronic messages to the next set of close social contacts until a list of social contacts is exhausted.

In some embodiments, the validation module 208 validates the value obtained from the social contact prior to providing the value to the requesting user. Various methods for validating the value may be used. In one embodiment, if multiple social contacts (e.g., five or more) have the same value in their address book for the individual, then the obtained value is determined to be highly accurate. In another embodiment, the process to obtain the value may not even be performed unless a minimum number of social contacts (e.g., three) have the requested value. A level of accuracy for the value may be provided to the user. For example, if less than three social contacts have the value in their respective address books, the validation module 208 may indicate that the value is unconfirmed or indicate that only two other users have that value.

The value provision module 210 manages the provisioning of the obtained value for the individual. Accordingly, the value provision module 210 may automatically provide the value to the user device of the user that sent the request, and the management application 110 on the user device may update the locally stored address book.

The data storage 212 may maintain various data used by the contact management system 102. In example embodiments, the data storage may comprise primary profiles for all individuals registered with or using applications associated with the contact management system 102. Each individual has a primary profile in the data storage 212 that the individual may be responsible for managing. In some embodiments, information in the primary profile of the individual may be copied to address books of social contacts of the individual. The data storage 212 may also comprise information used by the social contact module 202 to determine closeness of social contacts or likelihood of social contacts to respond such as past responses, indications of frequency of chats and mails between users, and other heuristics. It is noted that the data storage 212 may be a hardware storage device.

While example embodiments provide these modules in the contact management system 102, alternative embodiments may provide one or more of these modules in the management application 110 on the user device 106. Alternatively, some of the functions performed by the modules of the contact management system 102 may be performed by the management application 110.

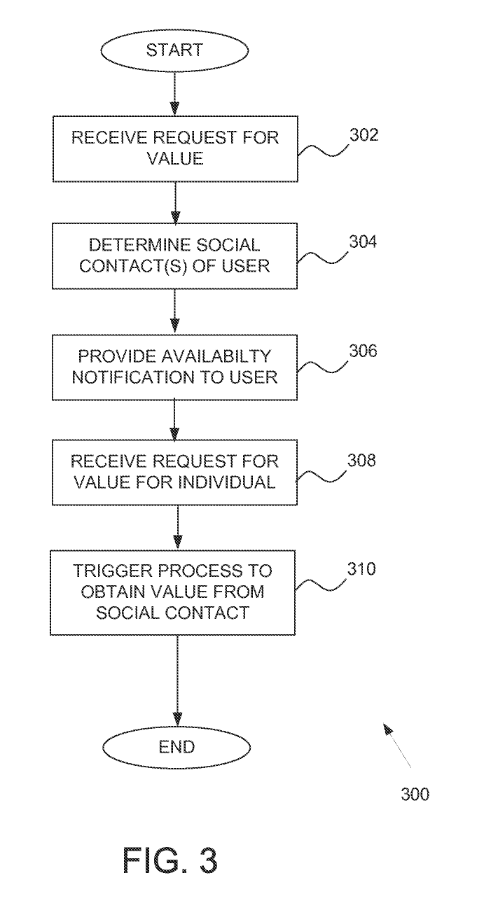

FIG. 3 is a flow diagram of an example method for managing contact information requests in a network. The contact management system 102 receives a request for a value for a contact in operation 302. The request for the value may, in some embodiments, be based on a search for a contact having a particular search criterion. For example, the user may perform a search for contacts with the name “Bob.” A list of one or more contacts matching the search criterion is returned to the user. The list of contacts may include contacts from the user's own address book and/or contacts from address books of social contacts that have granted the user permission to search their address books.

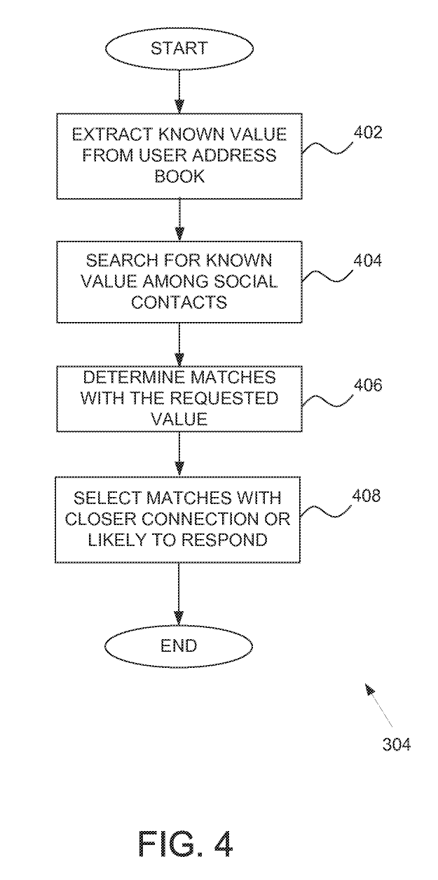

In operation 304, social contacts of the user that have the value are determined. One embodiment of operation 304 will be discussed in more detail in connection with FIG. 4 below.

If one or lore social contacts (or a minimum number of social contacts) are determined to have the value, the user is provided notification in operation 306. The notification may indicate that one or more social contacts have the value that the user is requesting in their address books. The notification may not indicate who these social contacts are; only that they exist (e.g., “Three of your friends have this value.”). The notification may also provide a selection (e.g., a button) to the user to enable the user to ask one or more of these social contacts to provide the value.

In example embodiments, a request for the value is received from the user in operation 308. The request may identify the individual corresponding to the contact for whom the value is requested and a value type (e.g., a mobile number, an email address). In some embodiments, the contact in the address book is determined to correspond to the individual based on a second value in the contact that is also contained in the primary profile of the individual that uniquely identifies the individual. The second value may be any one of an e-mail address, a mobile number, a chat account, a handle, a telephone number, or a social network identifier. In example embodiments, the request is received via the network 104 and may comprise, for example, an e-mail, a text message, an SMS message, or a voice message.

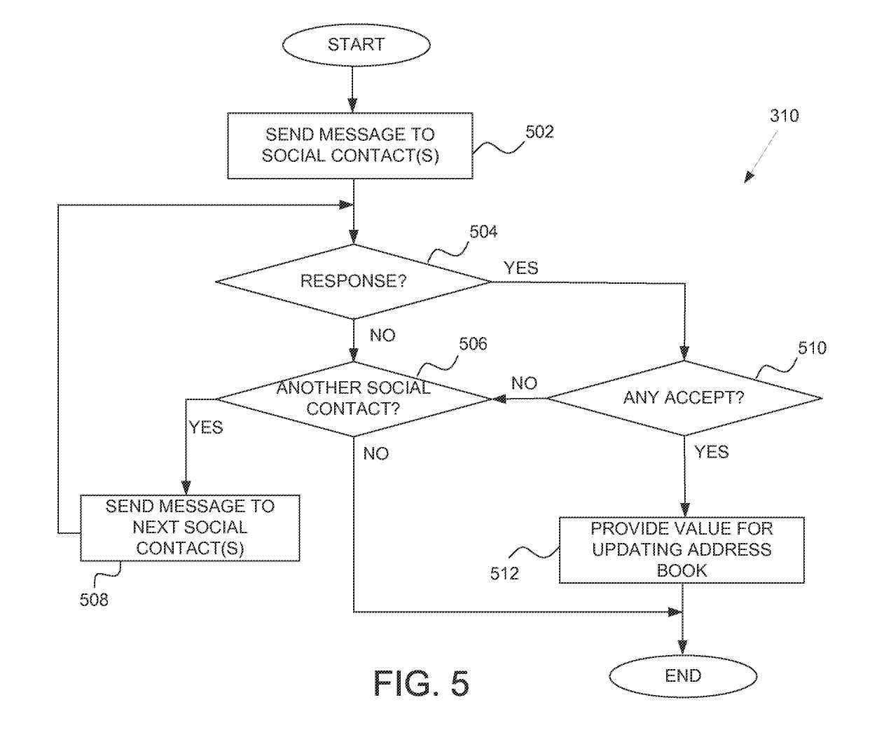

In operation 310, a process to obtain the value from a social contact is triggered. Operation 310 will be discussed in more detail in connection with FIG. 5 below.

FIG. 4 is a flow diagram of an example method for determining asocial contact from whom to request a value (e.g. operation 304). In example embodiments, the operations of the method may be performed by the social contact module 202. Users may be social contacts and are socially connected, for example, when the two users know each other or otherwise have a pre-existing relationship (e.g., direct relationship or relationship via one or more third parties). In operation 402, a known value for the contact for which the value is being requested may be extracted from the contact in the address book of the first user. Using the known value, one or more social contacts are determined based on the address book of the social contact containing the known value for the contact in operation 404. In various examples, the known value for the contact may be an email address, a mobile number, a phone number, and a chat account. Operations 402 and 404 are performed based on the request being for a value of a contact that exists in the user's address book. If the request is for a value of a contact that is not in the user's address book (e.g., based on the search returning the contact from an address book of a social contact), then operations 402 and 404 are not necessary.

In operations 406, social contacts with the known value and having the requested value are determined. These social contacts may be ordered in closeness or likelihood to respond, and social contacts that rank higher are chosen to receive an electronic message requesting the value first in operation 408. For example, social contacts that the requesting user chats with or e-mails more often may be considered to be closer than social contacts that the requesting user seldom communicates with. In another example, social contacts that have responded in the past to electronic messages requesting values are deemed more likely to respond to another electronic message request. Other heuristics that may indicate a social contact's likelihood to respond to the electronic message may also be considered. Additionally, the same social contacts should not be bombarded with an excess amount of electronic messages requesting values.

FIG. 5 is a flow diagram of an example method for obtaining the value from the social contact (e.g., operation 310). Once the requesting user provides an indication to request the value from one of the social contacts, the data exchange module 206 may send the electronic message to one or more of the social contacts in operation 502. In some embodiments, a top number of social contacts in closeness or likelihood to response (e.g., a top three) may receive the electronic message. The electronic message is a request to the social contact to provide the value (e.g., “John would like Ted's mobile number. Will you provide it?”). The electronic message may be sent by any means based on contact information (e.g., values) stored, for example, in the primary profile of the social contact. For example, the electronic message may be sent via e-mail if an e-mail address exists in a primary profile for the social contact or sent via text messaging if a mobile phone number exists in the primary profile for the social contact or via a chat message.

In operation 504, a determination is made as to whether a social contact responds to the electronic message. If none of the social contacts that were sent the electronic message in operation 502 responds within a predetermined amount time, a determination is made in operation 506 as to whether any further social contacts are available that have the requested value. If there are further social contacts, then the electronic message requesting the value may be sent to a next set of social contacts in operation 508.

If in operation 504, one or more responses are received from one of the social contacts, a determination is made in operation 510 if any of the response is acceptance or approval to providing the value to the requesting user. If all of the responses are a denial to providing the value (and no other outstanding response are expected), then a determination is made in operation 506 as to whether any further social contacts are available that have the requested value. If there are further social contacts, then the electronic message may be sent to the next set of social contacts requesting the value, and the electronic message is sent to the next set of social contacts in operation 508.

However, if one of the responses is approval of the request for the value in operation 510, then the value may be obtained from the accepting social contact. The value is then provided in operation 512 to the requesting user in order to update the requesting user's address book. In one embodiment, a component of the management application 110 at the user device of the accepting social contact may obtain the value from a locally stored address book and provide it to the data exchange module 206. In other embodiments, a component of the contact management system 102 may obtain the value from the (locally or remotely stored) address book of the accepting social contact. The requesting user may also be provided notification that the value has been incorporated into his address book. In some cases, the requesting user may also be provided an identity of the social contact that provided the value.

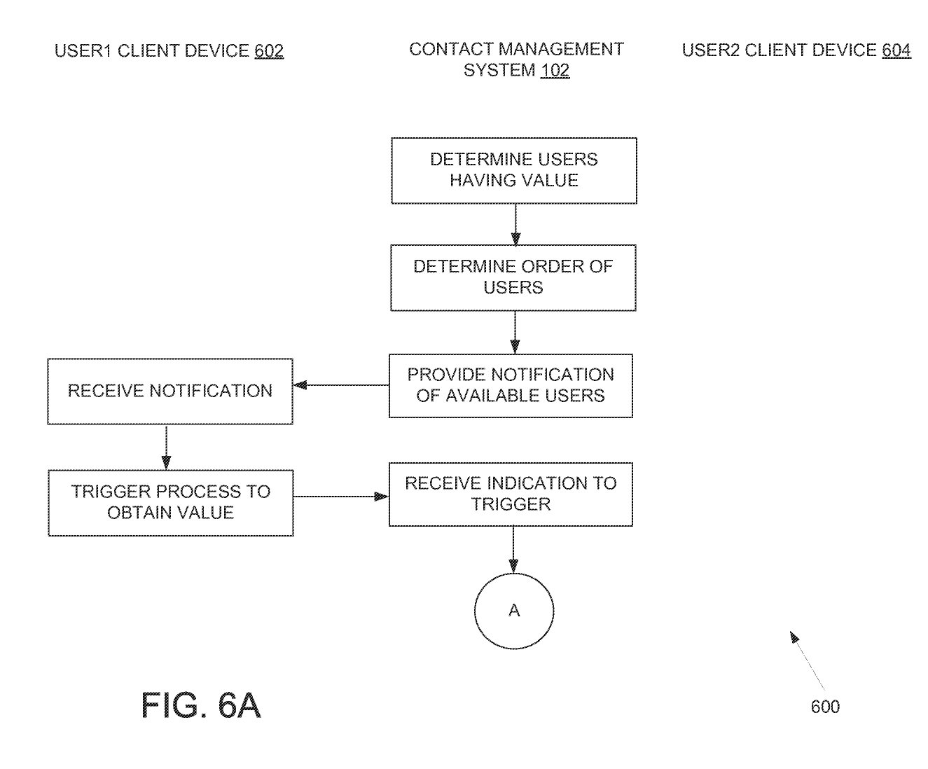

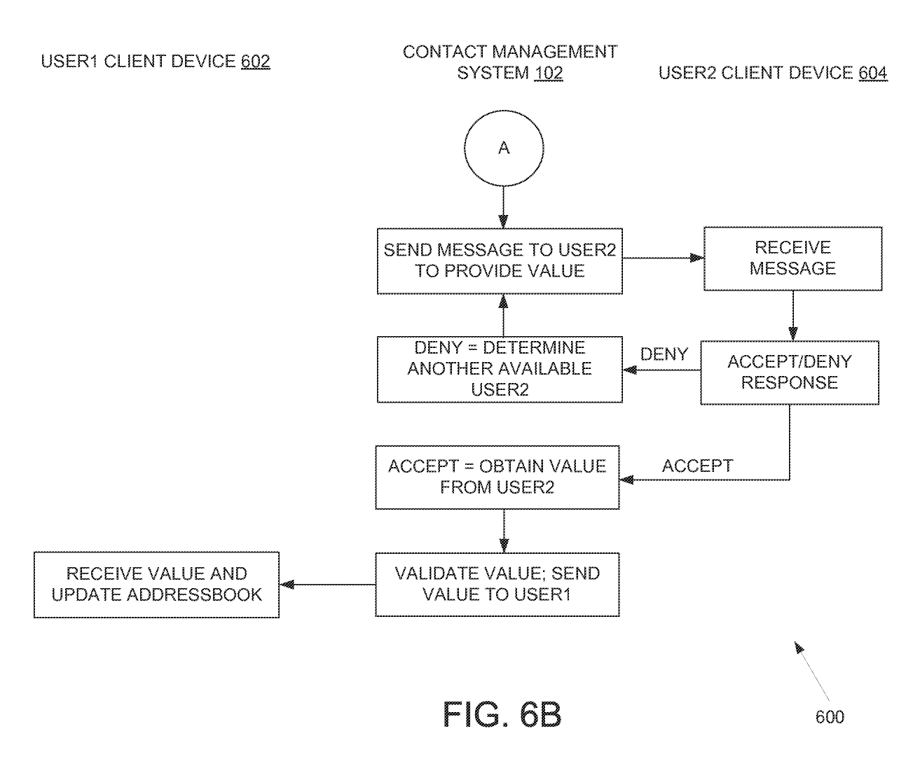

FIG. 6A and FIG. 6B are communication flow diagrams of an example method for managing contact information requests in the network. The contact management system 102 determines one or more social contacts that have the requested value. In example embodiments, social contacts' address books may be examined to see if they have the requested value (e.g., value missing from the first user's address book for the contact, or having the contact and value based on a selection from a search result for the contact). The social contacts that have the value are ordered in closeness or likelihood to respond to a request such that higher ordered social contacts may be asked to provide the value first. A notification may be provided to user1 of the availability of one or more user2 that can provide the requested value.

User1 receives the notification and can trigger a process to obtain the value from the social contacts. In one embodiment, the identities of the social contacts may not be provided in the notification, only an indication that there are social contacts that have the requested value. The notification also provides a mechanism (e.g., button, selection) for the user to trigger the process to obtain the value from one of the social contacts. The trigger is received by the contact management system 102.

In response to receiving the trigger, the contact management system 102 sends an electronic message to the social contacts (e.g., user 2 at user2 client device 604) based on closeness or likelihood to respond. The electronic message asks user2 whether they are willing to share the value with user1 and may identify who user1 is. The electronic message is received by the user2 client device 604 and user2 sends an electronic response to the electronic message. The electronic response or reply may be an acceptance or a denial. If the response is a denial (e.g., user2 refuses to share the value), then the contact management system 102 may send the electronic message to a next one or more social contacts in order of closeness. In some embodiments, this process of sending out further electronic messages may be repeated for only a certain number of times (e.g., for the top 10 social contacts or only three times). If the response is a denial and not all recipients of the electronic message have responded (e.g., when sent to a set of more than one social contacts), the contact management system 102 may wait until all of the recipients have responded (or a predetermined period of time) before sending the electronic message to the next set of social contacts.

If the response is an acceptance to provide the value, the value may be obtained from user 2 in accordance with some embodiments. For example, the requested value may be extracted from the address book of user2. Alternatively, the contact management system 102 may have knowledge of the value (e.g., stored in a primary profile or in the data storage 212), but will only provide the value upon a user2 indicating acceptance to provide the value.

The value may be validated be the contact management system 102. In one embodiment, if multiple social contacts (e.g., five or more) have the same value in their address book for the individual, then the obtained value is determined to be highly accurate. A level of accuracy for the value may be provided to the user. For example, if less than three social contacts have the value in their respective address books, the validation module 208 may indicate that the value is unconfirmed or indicate that only two other users have that value. It is noted that in some embodiments, the process to obtain the value may not even be performed unless a minimum number of social contacts (e.g., three) have the requested value in their respective address books. The value is then sent to the user1 diet device 602.

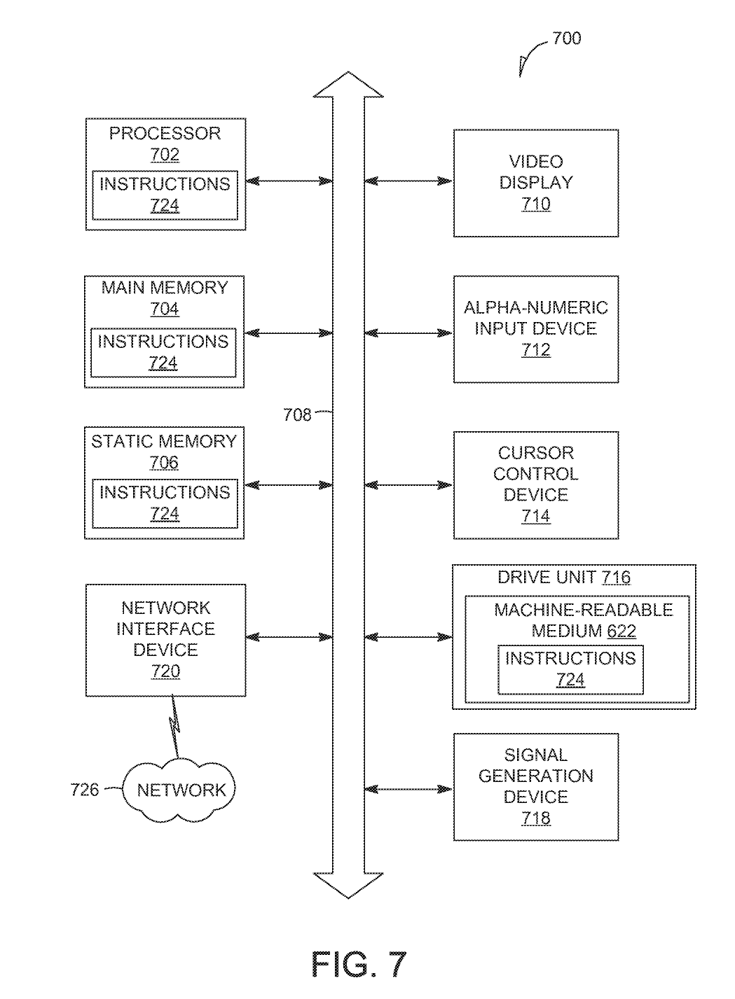

FIG. 7 is a block diagram illustrating components of a machine 700, according to some example embodiments, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system and within which instructions 724 (e.g., software, a program, an application, an applet, an app, or other executable code) for causing the machine 700 to perform any one or more of the methodologies discussed herein may be executed. In alternative embodiments, the machine 700 operates as a standalone device or may be connected (e.g., networked) to other machines. In a networked deployment, the machine 700 may operate in the capacity of a server machine or a client machine in a server-client network environment, or as a peer machine in a peer-to-peer (or distributed) network environment. The machine 700 may be a server computer, a client computer, a personal computer (PC), a tablet computer, a laptop computer, a netbook, a set-top box (STB), a personal digital assistant (PDA), cellular telephone, a smartphone, a web appliance, a network router, a network switch, a network bridge, or any machine capable of executing the instructions 724, sequentially or otherwise, that specify actions to be taken by that machine. Further, while only a single machine is illustrated, the term “machine” shall also be taken to include a collection of machines that individually or jointly execute the instructions 724 to perform any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The machine 700 may further include a graphics display 710 (e.g., a plasma display panel (PDP), alight emitting diode (LED) display, a liquid crystal display (LCD), a projector, or a cathode ray tube (CRT)). The machine 700 may also include an alpha-numeric input device 712 (e.g., a keyboard), a cursor control device 714 (e.g., a mouse, a touchpad, trackball, a joystick, a motion sensor, or other pointing instrument), a storage unit 716, a signal generation device 718 (e.g., a speaker), and a network interface device 720.

The storage unit 716 includes a machine-readable medium 722 on which is stored the instructions 724 embodying any one or more of the methodologies or functions described herein. The instructions 724 may also reside, completely or at least partially, within the main memory 704, within the processor 702 (e.g., within the processor's cache memory), or both, during execution thereof by the machine 700. Accordingly, the main memory 704 and the processor 702 may be considered as machine-readable media. The instructions 724 may be transmitted or received over a network 726 via the network interface device 720.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 722 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 700), such that the instructions, when executed by one or more processors of the machine (e.g., processor 702), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shalt accordingly be taken to include, but not be limited to, one or more data repositories in the form of a solid-state memory, an optical medium, a magnetic medium, or any suitable combination thereof.

The instructions 724 may further be transmitted or received over a communications network 726 using a transmission medium via the network interface device 720 and utilizing any one of a number of well-known transfer protocols (e.g., HTTP). Examples of communication networks include a local area network (LAN), a wide area network (WAN), the Internet, mobile telephone networks, POTS networks, and wireless data networks (e.g., Wifi and WiMAX networks). The term “transmission medium” shall be taken to include any intangible medium that is capable of storing, encoding, or carrying instructions for execution by the machine, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
receiving, at a contact management system from a user device of a first user, a request requesting a value for a contact;
selecting, using a processor of a machine, a second user socially connected to the first user and having the value for the contact in an address book of the second user;
sending an electronic message to a user device of the second user requesting the second user to provide the value to the first user; and
providing the value to the first user based on an approval by the second user in response to the electronic message.

2. The method of claim 1, further comprising:
receiving, from the first user, a contact search communication that includes a search criterion;
determining one or more contacts that match the search criterion; and
providing the one or more contacts that match the search criterion to the first user from which the contact is selected to request the value.

3. The method of claim 2, wherein the one or more contacts that match the search criterion are determined from the address book of the second user, the second user granting access to the first user to search the address book of the second user.

4. The method of claim 2, wherein the one or more contacts that match the search criterion are determined from an address book of the first user.

5. The method of claim 1, wherein based on the contact being in an address book of the first user, further comprising:
extracting a known value for the contact from the address book of the first user; and
determining the second user based on the address book of the second user containing the known value for the contact and the value being requested, wherein the known value for the contact comprises a selection from a group consisting of an email address, a mobile number, a phone number, and a chat account.

6. The method of claim 1, further comprising:
based on a denial or timeout by the second user in response to the electronic message, determining whether a next set of one or more socially connected users are available to send the electronic message requesting the value; and
sending the electronic message to the next set of one or more socially connected users based on availability.

7. The method of claim 1, further comprising:
causing a notification to be presented to the first user indicating that a set of users socially connected to the first user has the value; and
receiving an indication from the first user to send the electronic message to one or more users of the set of users, the one or more users including the second user.

8. The method of claim 7, wherein an identity of the second user that has the value is not revealed to the first user in the notification.

9. The method of claim 1, wherein the selecting comprises:
identifying a set of users socially connected to the first user that has the value, and
choosing one or more users of the set of users based on a selection from the group consisting of availability of the one or more users in real time, number of past requests received by the one or more users, number of past requests approved by the one or more users, and a number of past interactions between the first user and the one or more users, the one or more users including the second user.

10. The method of claim 1, wherein the selecting comprises:
identifying a set of users socially connected to the first user that has the value; and
choosing one or more users of the set of users based on the one or more users having the value that most others have for the contact in order to increase a probability of accuracy of the value, the one or more users including the second user.

11. The method of claim 1, wherein the electronic message provides an option to the second user to approve or deny providing of the value.

12. The method of claim 1, wherein the providing of the value comprises copying the value from the address book of the second user and providing the copied value to the first user.

13. The method of claim 1, further comprising:
receiving an indication of the approval by the second user in response to the electronic message; and
notifying the first user that the value is incorporated into the address book of the first user.

14. The method of claim 13, further comprising providing an identity of the second user that provided the value.

15. A tangible machine-readable storage medium having instructions that, when executed by one or more processors, performs operations comprising:
receiving, at a contact management system from a user device of a first user, a request requesting a value for a contact;
selecting a second user socially connected to the first user and having the value for the contact in an address book of the second user;
sending an electronic message to a user device of the second user requesting the second user to provide the value to the first user; and
providing the value to the first user based on an approval by the second user in response to the electronic message.

16. The tangible machine-readable storage medium of claim 15, wherein the operations further comprise:
based on a denial or timeout by the second user in response to the electronic message, determining whether a next set of one or more socially connected users are available to send the electronic message requesting the value; and
sending the electronic message to the next set of one or more socially connected users based on availability.

17. The tangible machine-readable storage medium of claim 15, wherein the operations further comprise:
receiving, from the first user, a contact search communication that includes a search criterion;
determining one or more contacts that match the search criterion; and
providing the one or more contacts that match the search criterion to the first user from which the contact is selected to request the value.

18. The tangible machine-readable storage medium of claim 17, wherein the one or more contacts that match the search criterion are determined from the address book of the second user, the second user granting access to the first user to search the address book of the second user.

19. The tangible machine-readable storage medium of claim 15, wherein the selecting comprises:
identifying a set of users socially connected to the first user that bias the value; and
choosing one or more users of the set of users based on the one or more users having the value that most others have for the contact in order to increase a probability of accuracy of the value, the one or more users including the second user.

20. A system comprising:
a processor of a machine;
a request module to receive, at a contact management system from a user device of a first user, a request requesting a value for a contact in an address book of the first user;
a social contact module to select, using the processor of a machine, a second user socially connected to the first user and having the value for the contact in an address book of the second user;
a data exchange module to send an electronic message to a user device of the second user requesting the second user to provide the value to the first user; and
a value provision module to provide the value to the first user based on an approval by the second user in response to the electronic message.
